(19) United States
(12) Patent Application Publication
(10) Pub. No.: US 2024/0367984 A1
(43) Pub. Date: Nov. 7, 2024

(54) HYBRIDIZED AEROGEL HAVING HIGH TEMPERATURE STABILITY AND HIGH THERMAL INSULATION PROPERTY, METHOD OF MANUFACTURING HYBRIDIZED AEROGEL, AEROGEL-BASED INSULATOR AND METHOD OF MANUFACTURING AEROGEL-BASED INSULATOR

(71) Applicant: APIT Inc., Seoul (KR)

(72) Inventors: Hyung-Ho Park, Seoul (KR); Haryeong Choi, Seoul (KR); Taehee Kim, Seoul (KR); Jiseung Kim, Seoul (KR); Wonjun Lee, Seoul (KR)

(21) Appl. No.: 18/654,291

(22) Filed: May 3, 2024

(30) Foreign Application Priority Data
May 4, 2023 (KR) 10-2023-0058198

(51) Int. Cl. C01B 33/158; C01B 33/151; C01B 33/154; H01B 3/00

(52) U.S. Cl. CPC C01B 33/1585; C01B 33/151; C01B 33/1546; H01B 3/006; C01P 2006/32

(57) ABSTRACT

Provided is a method of manufacturing a hybridized aerogel including preparing a silica sol including a silica precursor, a first organic solvent, and a first acidic catalyst, preparing an opacifier sol including an opacifier precursor, a second organic solvent, a gelation inducing agent, and a second acidic catalyst, forming a mixed sol by mixing the silica sol and the opacifier sol, forming a hybridized gel in which a silica gel and an opacifier gel are mixed by adding a basic catalyst to the mixed sol and making the mixed sol to be gelled, and acquiring a hybridized aerogel in which a silica aerogel and an opacifier aerogel are mixed by removing solvent from the hybridized gel.

### CROSS-REFERENCE TO RELATED APPLICATION

This application claims priority of Korean Patent Application No. 10-2023-0058198, filed on May 4, 2023, in the KIPO (Korean Intellectual Property Office), the disclosure of which is incorporated herein entirely by reference.

### BACKGROUND OF THE INVENTION

### Field of the Invention

The present invention relates to aerogel, members to which aerogel is applied, and manufacturing methods thereof, and more particularly, to aerogel, a method of manufacturing aerogel, an aerogel-based insulating member, and a method of manufacturing an aerogel-based insulating member.

### Description of the Related Art

An aerogel blanket refers to a product manufactured by complexing aerogel with various organic/inorganic fiber sheets. The fibers complexed with aerogel provide flexibility and moldability, and aerogel provides unique high insulation properties. Fiber sheets complexed with aerogel become a substance with high insulation properties, formability and flexibility, and may be processed and used as a modified form in various industrial fields which require insulation properties. Aerogel blankets are manufactured by applying or impregnating silica sol obtained from water glass or alkoxide-based precursors to fibers to form silica gel within the fibers, and then forming silica aerogel complexed with the fibers through a drying process. The manufactured aerogel blanket has very low room temperature thermal conductivity due to nano-sized pores and low solid fraction.

However, silica aerogel, which is the main component of existing commercialized aerogel blankets, does not absorb or scatter electromagnetic waves with a wavelength in the range of about 2 to 8 μm emitted from a high-temperature heat source and mostly transmits them. In order to improve this problem, a method for suppressing thermal radiation heat transfer by adding an opacifier to absorb or scatter electromagnetic waves which contribute to heat conduction in a high temperature environment has been proposed.

According to the proposed existing method, an aerogel blanket is prepared by using a single phase of silica aerogel and adding opacifier powder. That is, according to the existing method, an opacifier powder was added during the aerogel blanket manufacturing process to manufacture an aerogel blanket to which the opacifier powder was added. However, when an aerogel blanket is manufactured by using this method, there is a problem that the added opacifier is easily broken off and scatters even with a small impact because it is physically bonded. Additionally, even when the aerogel blanket is exposed to a high-temperature environment and serves as an insulating substance, there is a problem that a scattering phenomenon is increased due to agglomeration of the opacifier powder occurs. Therefore, when manufacturing an aerogel blanket, only a small amount of opacifier powder is added. As a result, the amount of the added opacifier suppress electromagnetic waves generated from high-temperature heat sources is limited, and high-temperature stability is reduced. In addition, because the opacifier powder is physically added, the reproducibility of physical properties decreases and structural stability deteriorates. The pore structure of an aerogel blanket, which lacks the ability to suppress radiant heat and has poor structural stability, may easily collapse at high temperatures, and the insulation properties may deteriorate due to deterioration of pore properties.

Therefore, development of the concerned technologies and methods are required to solve the problems such as increased scattering due to simple addition of opacifier powder, increased thermal conductivity due to removal/reduction of opacifier in a high-temperature environment, deterioration of pore properties of aerogel, and deterioration of insulation properties.

### SUMMARY OF THE INVENTION

The technological object to be achieved by the present invention is to provide an aerogel-based insulator which may secure high-temperature stability and high insulation properties by preventing scattering of an opacifier and suppressing the problems such as increased thermal conductivity, deterioration of pore characteristics, and deterioration of thermal insulation properties which are generated due to removal/reduction of the opacifier, and a manufacturing method thereof.

In addition, the technological object to be achieved by the present invention is to provide an aerogel-based insulator which may prevent scattering problem by hybridizing the opacifier as a form of an aerogel, may also maintain high insulation properties by suppressing the deterioration of the pore structure and heat conduction in a high temperature environment, and may provide formability (moldability) and processability through hybridization (combination) with a matrix, and its manufacturing method.

In addition, the technological object to be achieved by the present invention is to provide a hybridized aerogel which may be applied to the above-described aerogel-based insulator and a method of manufacturing the same.

The objects to be achieved by the present invention are not limited to the objects mentioned above, and other objects not mentioned will be understood by those skilled in the art from the description below.

According to one embodiment of the present invention, a hybridized aerogel comprising a silica aerogel; and an opacifier aerogel mixed with the silica aerogel is provided.

The opacifier aerogel may include at least one of alumina aerogel, titania aerogel, and zirconia aerogel.

A content of the opacifier aerogel in the hybridized aerogel may be about 35 wt % or less.

A room temperature thermal conductivity of the hybridized aerogel may be about 40 mW/mK or less.

A high-temperature thermal conductivity of the hybridized aerogel in the range of 300 to 1000° C. may be in a range of about 40 to 60 mW/mK.

According to another embodiment of the present invention, there is provided a method of manufacturing a hybridized aerogel comprising: preparing a silica sol including a silica precursor, a first organic solvent, and a first acidic catalyst; preparing an opacifier sol including an opacifier sol precursor, a second organic solvent, a gelation inducing agent, and a second acidic catalyst; forming a mixed sol by mixing the silica sol and the opacifier sol; forming a hybridized gel in which a silica gel and an opacifier gel are mixed by adding a basic catalyst to the mixed sol and making the mixed sol to be gelled; and acquiring a hybridized aerogel in which a silica aerogel and an opacifier aerogel are mixed by removing solvent from the hybridized gel.

The preparing the opacifier sol may include at least one of preparing an alumina sol, preparing a titania sol, and preparing a zirconia sol.

The opacifier aerogel may include at least one of alumina aerogel, titania aerogel, and zirconia aerogel.

In the forming the mixed sol, the silica sol and the opacifier sol may be mixed so that a molar ratio of the opacifier precursor to the silica precursor may be about 20% or less.

The gelation inducing agent may include at least one of propylene oxide, cis-2,3-epoxybutane, 1,2-epoxybutane, and glycidol, epibromohydrin, trimethylene oxide, and 3,3-dimethyloxetane.

A room temperature thermal conductivity of the hybridized aerogel may be about 40 mW/mK or less.

A high-temperature thermal conductivity of the hybridized aerogel in the range of 300 to 1000° C. may be in a range of about 40 to 60 mW/mK.

According to another embodiment of the present invention, there is provided an aerogel-based insulator comprising a matrix; and a hybridized aerogel combined with the matrix, and including a silica aerogel and an opacifier aerogel mixed with the silica aerogel.

The matrix may include at least one of a blanket and a foam.

The matrix may include at least one of mullite fiber, carbon fiber, glass wool, mineral wool, styrofoam, melamine foam, urethane foam, and phenolic foam.

The matrix may include a fiber member, and a fiber diameter of the fiber member may be in a range of about 1 to 10 μm. A density of the fiber member may range from about 0.1 to 0.9 g/cm3.

The opacifier aerogel may include at least one of alumina aerogel, titania aerogel, and zirconia aerogel.

A content of the opacifier aerogel in the hybridized aerogel may be about 35 wt % or less.

A room temperature thermal conductivity of the hybridized aerogel may be about 40 mW/mK or less.

A high-temperature thermal conductivity of the hybridized aerogel in a range of 300 to 1000° C. may be in a range of about 40 to 60 mW/mK.

According to another embodiment of the present invention, there is provided a method of manufacturing aerogel-based insulator comprising: preparing a silica sol including a silica precursor, a first organic solvent, and a first acidic catalyst; preparing an opacifier sol including an opacifier sol precursor, a second organic solvent, a gelation inducing agent, and a second acidic catalyst; forming a mixed sol by mixing the silica sol and the opacifier sol; forming a hybridized gel including a silica gel and an opacifier solgel gelated from the mixed sol, and combined with a matrix by adding a basic catalyst to the mixed sol, and impregnating the matrix into the mixed sol to which the basic catalyst is added; and acquiring an aerogel-based insulator including the matrix and a hybridized aerogel combined therewith by forming the hybridized aerogel in which a silica aerogel and an opacifier aerogel are mixed by removing solvent from the hybridized gel.

The matrix may include at least one of a blanket and a foam.

The matrix may include at least one of mullite fiber, carbon fiber, glass wool, mineral wool, styrofoam, melamine foam, urethane foam, and phenolic foam.

The matrix may include a fiber member, and a fiber diameter of the fiber member may be in a range of about 1 to 10 μm. A density of the fiber member may range from about 0.1 to 0.9 g/cm3.

The preparing the opacifier sol may include at least one of preparing an alumina sol, preparing a titania sol, and preparing a zirconia sol.

The opacifier aerogel may include at least one of alumina aerogel, titania aerogel, and zirconia aerogel.

In the forming the mixed sol, the silica sol and the opacifier sol may be mixed so that a molar ratio of the opacifier precursor to the silica precursor may be about 20% or less.

The gelation inducing agent the gelation inducing agent includes at least one of propylene oxide, cis-2,3-epoxybutane, 1,2-epoxybutane, and glycidol, epibromohydrin, trimethylene oxide, and 3,3-dimethyloxetane.

Treating a surface of the matrix with acid may be further included before impregnating the matrix into the mixed sol.

Heat treating the matrix at a temperature of about 300 to 900° C. may be further included before impregnating the matrix into the mixed sol.

The forming the hybridized gel involves a process of immersing the matrix in the mixed sol, impregnating the matrix under a vacuum condition in a range of about 0.1 to −0.1 MPa, and then gelling the mixed sol at a temperature of about 40 to 60° C.

Performing aging and solvent exchange on the hybridized gel may be further included between the forming the hybridized gel and the acquiring the aerogel-based insulator.

Post-heat treating the aerogel-based insulator may be further included.

The post-heat treatment for the aerogel-based insulator may be performed at a temperature of about 300 to 900° C. in an air, oxygen, or inert gas atmosphere.

A room temperature thermal conductivity of the hybridized aerogel may be about 40 mW/mK or less.

A high-temperature thermal conductivity of the hybridized aerogel in a range of 300 to 1000° C. may be in a range of about 40 to 60 mW/mK.

According to the embodiments of the present invention, an aerogel-based insulator which may secure high temperature stability and high insulation properties may be implemented by preventing scattering of the opacifier and suppressing problems such as increased thermal conductivity, deterioration of pore characteristics, and deterioration of thermal insulation properties due to removal/reduction of the opacifier. In addition, according to embodiments of the present invention, it is possible to implement an aerogel-based insulator which may prevent scattering problem by hybridizing the opacifier as a form of an aerogel, may also maintain high insulation properties by suppressing the deterioration of the pore structure and heat conduction in a high temperature environment, and may provide formability (moldability) and processability through hybridization (combination) with a matrix.

The aerogel-based insulator manufactured according to an embodiment of the present invention may have high insulation properties and, for example, may have a room temperature thermal conductivity of about 40 mW/mK or less.

In addition, the aerogel-based insulator manufactured according to an embodiment of the present invention may have high insulation properties even at high temperatures due to the influence of the opacifier, and for example, has a thermal conductivity in the range of about 40 to 60 mW/mK in a high temperature environment.

In addition, since the aerogel-based insulator manufactured according to an embodiment of the present invention is a hybridization of the opacifier as a form of aerogel rather than powder, an effect may be obtained that scattering is greatly reduced or scattering is prevented as compared to an aerogel blanket commercialized in technologically advanced countries.

In addition, because the aerogel-based insulator manufactured according to an embodiment of the present invention includes a hybridized aerogel, an effect may be obtained that rate of change of thermal conductivity, density, and specific surface area due to high temperature heat treatment is reduced as compared to a commercialized aerogel blanket composed of a single phase which is produced from technologically advanced countries.

However, the effects of the present invention are not limited to the above effects and may be expanded in various ways without departing from the technological spirit and scope of the present invention.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a flowchart illustrating a method for manufacturing a hybridized aerogel according to an embodiment of the present invention.

FIG. 2 is a flowchart for explaining a method of manufacturing an aerogel-based insulator according to an embodiment of the present invention.

FIG. 3 is a scanning electron microscope (SEM) image of a hybridized aerogel manufactured according to embodiments of the present invention.

FIG. 4 is a graph showing the results of Fourier transform infrared spectroscopy (FT-IR) analysis of hybridized aerogels manufactured according to embodiments of the present invention.

FIG. 5 is a graph showing the results of energy dispersive spectroscopy (EDS) analysis of a hybridized aerogel manufactured according to an embodiment of the present invention.

FIG. 6 is an EDS mapping analysis image for a hybridized aerogel manufactured according to an embodiment of the present invention.

FIG. 7 is a graph showing the results obtained by a comparative evaluation of the weight reduction rate according to heat treatment of an aerogel-based insulator (aerogel blanket) to which a hybridized aerogel manufactured according to embodiments of the present invention is applied and an aerogel blanket commercialized in technologically advanced countries.

FIG. 8 is a graph showing the results obtained by comparative evaluation of respective change rate of a specific surface area, thermal conductivity, and density due to heat treatment of a hybridized aerogel manufactured according to an embodiment of the present invention and a single silica aerogel.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

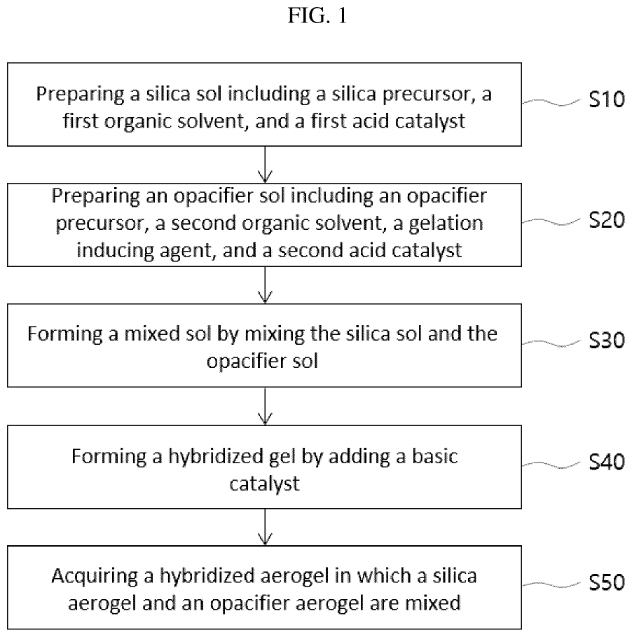

FIG. 1 is a flowchart illustrating a method for manufacturing hybridized aerogel according to an embodiment of the present invention. Below, a method for manufacturing a hybridized aerogel according to an embodiment of the present invention and the hybridized aerogel produced by this method will be described with reference to FIG. 1.

Referring to FIG. 1, the method for manufacturing a hybridized aerogel according to an embodiment of the present invention may include a step S10 for preparing a silica sol including a silica precursor, a first organic solvent, and a first acid catalyst, a step S20 for preparing an opacifier sol comprising an opacifier precursor (opacifying agent precursor), a second organic solvent, a gelation inducing agent, and a second acid catalyst, a step S30 for forming a mixed sol by mixing the silica sol and the opacifier sol, a step S40 for forming a hybridized gel in which a silica gel and an opacifier gel are mixed by adding a basic catalyst to the mixed sol and making the mixed sol to be gelled, and a step S50 for acquiring a hybridized aerogel in which a silica aerogel and an opacifier aerogel are mixed by removing the solvent from the hybridized gel.

The silica precursor used in step S10 is a hydrolyzable precursor, and as a non-limiting example, it may include one or more species selected from the group consisting of tetraethyl orthosilicate, tetramethyl orthosilicate, methyltrimethoxysilane, ethyltrimethoxysilane, methyltriethoxysilane, ethyltriethoxysilane, sodium metasilicate, 3-aminopropyltriethoxysilane, trimethylchlorosilane, and so on. As a non-limiting example, the first organic solvent may include at least one selected from the group consisting of ethanol, methanol, acetone, isopropanol, acetonitrile, n-methyl-2-pyrrolidone, hexane, ethyl acetate, dimethyl sulfoxide, and the like. As a non-limiting example, the first acid catalyst may include at least one selected from the group consisting of hydrochloric acid, nitric acid, oxalic acid, acetic acid, hydrofluoric acid, sulfuric acid, phosphoric acid, and so on. The first acidic catalyst may be, for example, an aqueous solution.

After dissolving the silica precursor in the first organic solvent in step S10, for example, it is possible to synthesize a hydrolyzed sol suspension, that is, the silica sol by catalyzing the solution with the first acid catalyst for about 1 hour or more. In the step S10, the silica precursor may be included in an amount of about 10 to 30 vol %, the first organic solvent may be included in an amount of about 60 to 87 volt, and the first acidic catalyst may be included in an amount of about 3 to 10 vol % based for the total silica sol. If necessary, the silica sol may be prepared by mixing water (purified water) with the silica precursor, the first organic solvent, and the first acid catalyst in step S10. In this case, about 2 to 9 vol % of water (purified water) may be included based for the total silica sol.

The step S20 may include, for example, at least one of a step for preparing an alumina sol, a step for preparing a titania sol, and a step for preparing a zirconia sol. The opacifier sol may include at least one of the alumina sol, the titania sol, and the zirconia sol. In the step S20, at least one of the alumina sol, the titania sol, and the zirconia sol may be prepared, respectively.

The alumina precursor which is an opacifier precursor used to form the alumina sol may include at least one selected from the group consisting of aluminum-tri-sec-butoxide, aluminum isopropoxide, aluminum chloride hexahydrate, and the like, as a non-limiting example. The titania precursor which is an opacifier precursor used to form the titania sol may include, at least one selected from the group consisting of titanium butoxide, titanium tetrachloride, titanium isopropoxide and the like, as a non-limiting example. The zirconia precursor which is an opacifier precursor used to form the zirconia sol, may include at least one selected from the group consisting of zirconyl chloride octahydrate, zirconyl oxynitrate hydrate, zirconium butoxide, and the like, as a non-limiting example.

The second organic solvent may include at least one selected from the group consisting of ethanol, methanol, acetone, isopropanol, acetonitrile, n-methyl-2-pyrrolidone, hexane, ethyl acetate, dimethyl sulfoxide, and the like, as a non-limiting example. As a non-limiting example, the second acid catalyst may include at least one selected from the group consisting of hydrochloric acid, nitric acid, oxalic acid, acetic acid, hydrofluoric acid, sulfuric acid, phosphoric acid, and the like. The second acidic catalyst may be, for example, an aqueous solution.

The gelation inducing agent may play a role in promoting the gelation reaction in the step S40. In this respect, the gelation inducing agent may be referred to as a ‘gelation accelerator’. The gelation inducing agent may include at least one of propylene oxide, cis-2,3-epoxybutane, and 1,2-epoxybutane, glycidol, epibromohydrin, trimethylene oxide, and 3,3-dimethyloxetaneas as a non-limiting example. The specific surface area of the hybridized aerogel formed later may be increased, mechanical strength may be improved, and thermal conductivity may be lowered by appropriately using the gelation inducing agent.

In step S20, for example, it is possible to synthesize a hydrolyzed sol suspension, that is, the opacifier sol by dissolving the opacifier precursor in the second organic solvent, and then adding the gelation inducing agent, for example, by catalyzing the solution with the second acidic catalyst for about 1 hour or more. In the step S20, the opacifier precursor may be included in an amount of about 12 to 18 vol %, the second organic solvent may be included in an amount of about 60 to 75 vol %, the gelation inducing agent may be included in an amount of about 8 to 15 vol %, and the second acidic catalyst may be included in an amount of about 5 to 7 vol % based for the entire opacifier sol.

In the step S30, the silica sol and the opacifier sol may be mixed to form the mixed sol. According to one embodiment, in step S30, the silica sol and the opacifier sol may be mixed so that the molar ratio of the opacifier precursor to the silica precursor may be about 20% or less. In other words, the silica sol and the opacifier sol may be mixed so that 0.2 mol or less of the opacifier precursor molecules may be included per mole of the silica precursor molecule. The molar ratio may be greater than 0 and less than or equal to about 20%. If the molar ratio of the opacifier precursor is greater than about 20%, the fraction of the opacifier aerogel in the hybridized aerogel formed later may be excessively increased, which may have a negative effect on improving the physical properties of the hybridized aerogel. Accordingly, it may be desirable for the molar ratio of the opacifier precursor to be about 20% or less.

According to one embodiment, the step S20 may include a step for preparing one or two or more types of opacifier sol, and in the step S30, the one or two or more types of opacifier sols may be mixed with the silica sol to form a mixed sol. When there are two or more types of opacifier sols, the silica sol and the two or more types of opacifier sols may be mixed so that the total amount of opacifier precursors in the two or more types of opacifier sols may be about 20% or less in mole ratio compared to the silica precursor.

In the step S40, a basic catalyst may be added to the mixed sol to gel the mixed sol. Thus, it is possible to form a hybridized gel in which a silica gel and an opacifier gel are mixed. The basic catalyst may include at least one selected from the group consisting of ammonium hydroxide, triethylamine, propylene oxide, urea, sodium hydroxide, potassium hydroxide, tetrabutyl ammonium fluoride, and the like, as a non-limiting example. The mixed sol may be catalyzed by adding the basic catalyst to induce gelation by condensation polymerization.

According to one embodiment, a step for performing aging and solvent exchange for the hybridized gel may be further included between steps S40 and S50. The aging of the hybridized gel may be performed for at least 1 day, and a solvent exchange process of at least 3 times or more may be performed and/or a solvent exchange process of at least 1 day or more may be performed. As a specific example, the pore structure of the hybridized gel may be strengthened by aging in an oven at a temperature of about 40 to 60° C. for more than 1 day, and strengthening of the pore structure and removal of unreacted substances may be carried out by performing a solvent exchange process of about 3 times a day for about 2 days. However, the above-described aging and solvent exchange conditions are exemplary and may vary depending on the case.

In the step S50, a hybridized aerogel in which a silica aerogel and an opacifier aerogel are mixed may be obtained by removing the solvent from the hybridized gel. The process for removing the solvent from the hybridized gel may be considered a type of drying process. The step S50 may be performed, for example, by a supercritical drying process or an atmospheric pressure drying process (ambient pressure drying process). The supercritical drying process may use, for example, CO₂, ethanol, methanol, and the like as a supercritical fluid. In the case of the atmospheric pressure drying process, first of all, the surface modification process for the hybridized gel may be performed, and then the atmospheric pressure drying process may be performed.

The hybridized aerogel may include a silica aerogel and an opacifier aerogel mixed therewith. The opacifier aerogel may include, for example, at least one of alumina aerogel, titania aerogel, and zirconia aerogel. Therefore, the hybridized aerogel may include a combination of silica-alumina aerogel, silica-titania aerogel, silica-zirconia aerogel, silica-alumina-titania aerogel, silica-alumina-zirconia aerogel, silica-titania-zirconia aerogel, and silica-alumina-titania-zirconia aerogel, and the like. The silica aerogel may contain SiO₂, the alumina aerogel may contain Al₂O₃, the titania aerogel may contain TiO₂, and the zirconia aerogel may contain ZrO₂.

According to one embodiment, the content of the opacifier aerogel in the hybridized aerogel may be about 35 wt % or less. That is, the content of the opacifier aerogel as compared to the total amount of the silica aerogel and the opacifier aerogel may be about 35 wt % or less. This may be the result obtained by mixing the silica sol and the opacifier sol so that the molar ratio of the opacifier precursor to the silica precursor may be about 20% or less in step S30.

According to one embodiment, after step S50, a step for post-heat treating the hybridized aerogel may be further performed. Organic ligands present on the surface of the hybridized aerogel may be removed through the post-heat treatment. Therefore, it is possible to achieve an effect to prevent the problems caused by residual organic ligands by performing the post-heat treatment process. In addition, it is possible to form a hybridized aerogel having an opacifier, which is imparted with crystallinity and has a high index of refraction for electromagnetic waves radiated from a heat source. As a specific example, the post-heat treatment process for the hybridized aerogel may be performed in an air, oxygen, or inert gas (nitrogen, argon, and the like) atmosphere at a temperature of about 300 to 900° C. for about 1 hour or more. However, the specific conditions of the post-heat treatment process presented here are exemplary and may change depending on the case. The weight reduction of the hybridized aerogel due to the post-heat treatment may be within about 10%.

The room temperature thermal conductivity of the hybridized aerogel may be, for example, about 40 mW/mK or less. The high-temperature thermal conductivity of the hybridized aerogel in the range of about 300 to 1000° C. or in the range of about 300 to 700° C. may be, for example, in the range of about 40 to 60 mW/mK. Since the hybridized aerogel may have excellent high temperature stability and high thermal insulation properties, it may maintain excellent thermal insulation properties even at high temperatures.

Meanwhile, the density of the hybridized aerogel may be, for example, about 10 kg/m³˜200 kg/m³. The specific surface area of the hybridized aerogel may be, for example, about 200 m²/g or more. The pore size (average pore size) of the hybridized aerogel may be, for example, about 1 nm to 50 nm. The pore volume of the hybridized aerogel may be, for example, about 0.1 cm³/g˜5 cm³/g. The moisture content of the hybridized aerogel may be, for example, about 10 wt % or less.

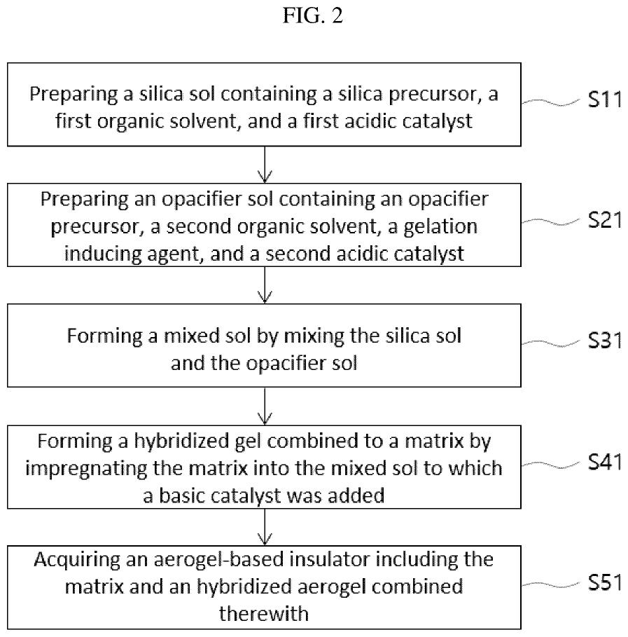

FIG. 2 is a flowchart for explaining a method of manufacturing an aerogel-based insulator according to an embodiment of the present invention. Below, a method for manufacturing an aerogel-based insulator according to an embodiment of the present invention and an aerogel-based insulator manufactured by this method will be described with reference to FIG. 2.

Referring to FIG. 2, a method of manufacturing an aerogel-based insulator according to an embodiment of the present invention may include a step S11 for preparing a silica sol containing a silica precursor, a first organic solvent, and a first acidic catalyst, a step S21 for preparing an opacifier sol containing an opacifier precursor, a second organic solvent, a gelation inducing agent, and a second acidic catalyst, a step S31 for forming a mixed sol by mixing the silica sol and the opacifier sol, a step S41 for forming a hybridized gel including a silica gel and an opacifier gel gelated from the mixed sol, and combined with a matrix by adding a basic catalyst to the mixed sol, and impregnating the matrix into the mixed sol to which the basic catalyst is added, and a step S51 of obtaining an aerogel-based insulator including the matrix and a hybridized aerogel combined therewith by forming the hybridized aerogel in which a silica aerogel and an opacifier aerogel are mixed by removing solvent from the hybridized gel.

Step S11 may be substantially the same as step S10 described with reference to FIG. 1. The step S21 may be substantially the same as step S20 described with reference to FIG. 1. The step S31 may be substantially the same as step S30 described with reference to FIG. 1.

In the step S41, the hybridized gel including a silica gel and an opacifier gel gelled from the mixed sol and combined with the matrix by adding a basic catalyst to the mixed sol, and impregnating the matrix into the mixed sol to which the basic catalyst is added may be formed. The basic catalyst may include at least one selected from the group consisting of ammonium hydroxide, triethylamine, propylene oxide, urea, sodium hydroxide, potassium hydroxide, tetrabutyl ammonium fluoride, and the like, as a non-limiting example. After adding the basic catalyst to the mixed sol to form a homogeneous solution (sol), the matrix may be impregnated into the mixed sol to which the basic catalyst has been added before gelation progresses. Gelation of the mixed sol may proceed while the mixed sol is impregnated with the matrix.

As a specific example, the step S41 may include a process of immersing the matrix into the mixed sol, impregnating the matrix under a vacuum condition in the range of about 0.1 to −0.1 MPa, and then gelling the mixed sol at a temperature of about 40 to 60° C. The matrix is immersed in the mixed sol and impregnated under the vacuum condition in the range of about 0.1 to −0.1 MPa, and when the vacuum condition is maintained for about 10 minutes or more, the mixed sol is evenly absorbed and dispersed into the interior of the matrix and as a result of it, gas remaining inside the matrix may be removed. For example, when the matrix is a fiber sheet, the mixed sol is evenly absorbed and dispersed into the interior of the fiber sheet, and gas remaining inside the fiber sheet may be removed. When the mixed sol is uniformly absorbed into the matrix, the subsequent process may be carried out in substantially the same manner as the hybridized aerogel manufacturing method described with reference to FIG. 1.

According to one embodiment, the matrix may include at least one of a blanket and a foam. For example, the matrix may be a blanket or a foam. When the matrix is a blanket, the blanket may include a predetermined fiber member. When the matrix is a blanket, the aerogel-based insulator finally manufactured may be referred to as an ‘aerogel blanket’. As a non-limiting example, the matrix may include at least one of mullite fiber, carbon fiber, glass wool, mineral wool, styrofoam, melamine foam, urethane foam, and phenolic foam.

When the matrix includes a fiber member, the fiber yarn diameter of the fiber member may be, for example, in the range of about 1 to 10 μm. Additionally, the density of the fiber member may be, for example, in the range of about 0.1 to 0.9 g/cm³. If these conditions are met, manufacturing of aerogel-based insulator may be easier. However, the appropriate conditions for the fiber member may vary depending on the case.

According to one embodiment, a step for treating the surface of the matrix with acid may be further performed before impregnating the matrix into the mixed sol. Adhesion and impregnation of the mixed sol to the matrix may be improved by creating a reactor and cleaning the surface through the acid treatment. Hydrochloric acid, acetic acid, nitric acid, sulfuric acid, and the like may be used for the acid treatment, and the acid treatment process may be performed for about 30 minutes or more. When the acid treatment is performed in advance, the adhesion of the aerogel to the matrix may be improved.

In addition, a step for heat treating the matrix may be further performed before impregnating the matrix into the mixed sol. Adhesion and impregnation of the mixed sol to the matrix may be improved by removing moisture and impurities from the matrix through the heat treatment. As a specific example, the matrix may be heat treated at a temperature of about 300 to 900° C. for about 1 hour or more before impregnating the matrix into the mixed sol. When the heat treatment is performed in advance, the adhesion of the aerogel to the matrix may be improved.

According to one embodiment, a step for performing aging and solvent exchange for the hybridized gel may be further included between the step S41 and the step S51. The maturation of the hybridized gel may be performed for at least 1 day, and a solvent exchange process of at least 3 times or more may be performed and/or a solvent exchange process of at least 1 day or more may be performed. As a specific example, the pore structure of the hybridized gel may be strengthened by maturing in an oven at a temperature of about 40 to 60° C. for more than 1 day, and strengthening of the pore structure and removal of unreacted substances may be carried out by performing a solvent exchange process about 3 times a day for about 2 days. However, the above-described aging and solvent exchange conditions are exemplary and may vary depending on the case.

In the step S51, it is possible to obtain an aerogel-based insulator including the matrix and a hybridized aerogel combined therewith by forming the hybridized aerogel in which a silica aerogel and an opacifier aerogel are mixed by removing solvent from the hybridized gel. The process for removing the solvent from the hybridized gel may be considered a type of drying process. The step S51 may be performed, for example, by a supercritical drying process or an atmospheric pressure drying process (ambient pressure drying process). The supercritical drying process may use, for example, CO₂, ethanol, methanol, and the like, as a supercritical fluid. In the case of the atmospheric pressure drying process, the surface modification process for the hybridized gel may be performed firstly, and then the atmospheric pressure drying process may be performed.

The hybridized aerogel may include silica aerogel and an opacifier aerogel mixed therewith. The opacifier aerogel may include, for example, at least one of alumina aerogel, titania aerogel, and zirconia aerogel. Therefore, the hybridized aerogel may include a combination of silica-alumina aerogel, silica-titania aerogel, silica-zirconia aerogel, silica-alumina-titania aerogel, silica-alumina-zirconia aerogel, silica-titania-zirconia aerogel, and silica-alumina-titania-zirconia aerogel, and the like.

According to one embodiment, the content of the opacifier aerogel in the hybridized aerogel may be about 35 wt % or less. That is, the content of the opacifier aerogel compared to the total amount of the silica aerogel and the opacifier aerogel may be about 35 wt % or less. This may be the result obtained by mixing the silica sol and the opacifier sol so that the molar ratio of the opacifier precursor to the silica precursor may be about 20% or less in the step S31.

According to one embodiment, a step for performing post-heat treatment of the aerogel-based insulator may be further carried out after step S51. Organic ligands present on the surface of the hybridized aerogel may be removed through the post-heat treatment. Therefore, it is possible to achieve an effect that the problems caused by residual organic ligands may be prevented by performing the post-heat treatment process. In addition, it is possible to form a hybridized aerogel having an opacifier sol which is imparted with crystallinity and has a high refractive index with respect to electromagnetic waves radiated from a heat source by performing the post-heat treatment process. As a specific example, the post-heat treatment process for the aerogel-based insulator may be performed in an air, oxygen, or inert gas (nitrogen, argon, and the like) atmosphere at a temperature of about 300 to 900° C. for about 1 hour or more. However, the specific conditions of the post-heat treatment process presented here are exemplary and may change depending on the case. The weight reduction of the hybridized aerogel due to the post-heat treatment may be within about 10%.

The room temperature thermal conductivity of the hybridized aerogel may be, for example, about 40 mW/mK or less. The high-temperature thermal conductivity of the hybridized aerogel in the range of about 300 to 1000° C. or in the range of about 300 to 700° C. may be, for example, in the range of about 40 to 60 mW/mK. Since the hybridized aerogel may have excellent high temperature stability and high thermal insulation properties, it may maintain excellent thermal insulation properties even at high temperatures.

Meanwhile, the density of the hybridized aerogel may be, for example, about 10 kg/m³˜200 kg/m³. The specific surface area of the hybridized aerogel may be, for example, about 200 m²/g or more. The pore size (average pore size) of the hybridized aerogel may be, for example, about 1 nm to 50 nm. The pore volume of the hybridized aerogel may be, for example, about 0.1 cm³/g˜5 cm³/g. The moisture content of the hybridized aerogel may be, for example, about 10 wt % or less.

According to one embodiment, the content of the hybridized aerogel in the aerogel-based insulator may be, for example, in the range of about 20 to 90 wt %. In the aerogel-based insulator substance, the hybridized aerogel may be disposed in combination with the matrix. The hybridized aerogel may be placed inside and outside the matrix. When the matrix has a pore structure or mesh structure, the hybridized aerogel may be disposed inside the pore structure or the mesh structure of the matrix. Additionally, the hybridized aerogel may be disposed on the outer surface of the matrix.

According to embodiments of the present invention, it is possible to manufacture an aerogel-based insulator which may prevent scattering problem by hybridizing the opacifier as a form of an aerogel, may also maintain high insulation properties by suppressing the deterioration of the pore structure and heat conduction in a high temperature environment, and may provide formability (moldability) and processability through hybridization (combination) with a matrix. In addition, according to an embodiment of the present invention, it is possible to manufacture an aerogel-based insulator which may secure high temperature stability and high insulation properties by preventing scattering of the opacifier and suppressing problems such as increased thermal conductivity, deterioration of pore characteristics, and deterioration of thermal insulation properties due to removal/reduction of the opacifier.

The aerogel-based insulator manufactured according to an embodiment of the present invention may have high insulation properties and, for example, may have a room temperature thermal conductivity of about 40 mW/mK or less. In addition, the aerogel-based insulator manufactured according to an embodiment of the present invention may have high insulation properties even at high temperatures due to the influence of the opacifier, and for example, has a thermal conductivity in the range of about 40 to 60 mW/mK in a high temperature environment.

In addition, since the aerogel-based insulator manufactured according to an embodiment of the present invention is a hybridization of the opacifier as a form of aerogel rather than powder, the effect may be obtained that the scattering is greatly reduced or the scattering is prevented as compared to aerogel blankets commercialized in technologically advanced countries. In addition, because the aerogel-based insulator manufactured according to an embodiment of the present invention includes hybridized aerogel, it is possible to obtain the effects that the change rate in thermal conductivity, density, and specific surface area due to high temperature heat treatment are reduced as compared to those of the commercialized aerogel blankets from technologically advanced countries which are composed of a single phase.

In addition, since the aerogel-based insulator manufactured according to an embodiment of the present invention is a uniform hybridization of the opacifier as a form of aerogel rather than powder, it may not only prevent/minimize removal of the opacifier, but also may improve structural stability, simplify manufacturing processes, and improve the reproducibility of physical properties.

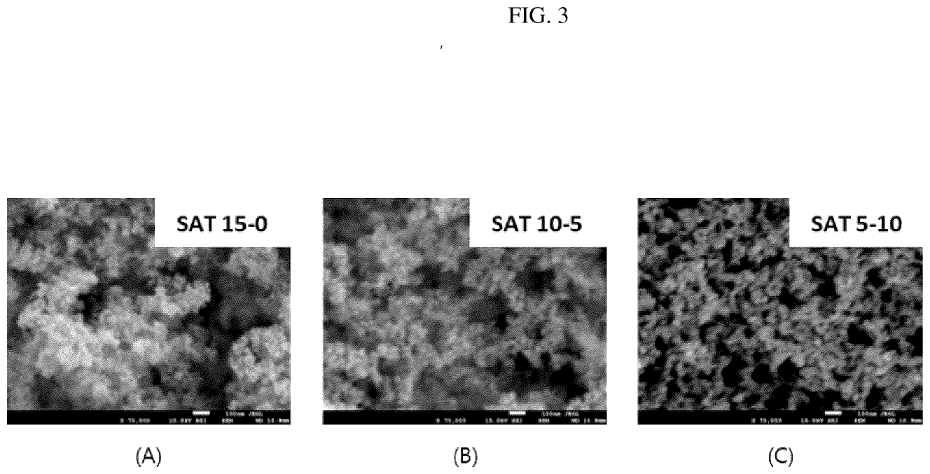

FIG. 3 is a scanning electron microscope (SEM) image of a hybridized aerogel manufactured according to embodiments of the present invention.

Referring to FIG. 3, a SEM image of the hybridized aerogel manufactured according to embodiments of the present invention may be confirmed. Here, SAT 15-0 represents a silica-alumina hybridized aerogel and corresponds to a case where silica sol and alumina sol (opacifier sol) are mixed so that the molar ratio of alumina precursor to silica precursor may be 15%. SAT 10-5 represents a silica-alumina-titania hybridized aerogel, and corresponds to a case that silica sol, alumina sol (opacifier sol), and titania sol (opacifier sol) are mixed so that the molar ratio of the alumina precursor to the silica precursor may be 10% and the molar ratio of the titania precursor to the silica precursor may be 5%. SAT 5-10 represents a silica-alumina-titania hybridized aerogel, and corresponds to a case that silica sol, alumina sol (opacifier sol), and titania sol (opacifier sol) are mixed so that the molar ratio of the alumina precursor to the silica precursor may be 5% and the molar ratio of the titania precursor to the silica precursor may be 10%. SAT 15-0, SAT 10-5 and SAT 5-10 are all heat-treated hybridized aerogels. From FIG. 3, the microstructure of the hybridized aerogel may be roughly confirmed.

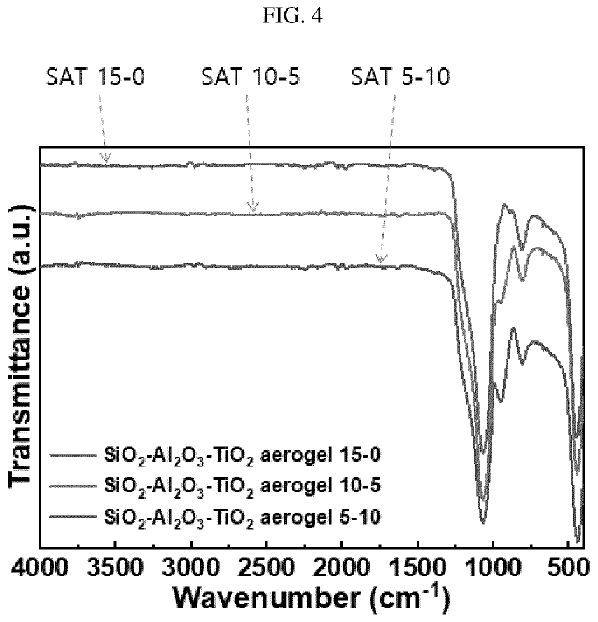

FIG. 4 is a graph showing the results of Fourier transform infrared spectroscopy (FT-IR) analysis of hybridized aerogels manufactured according to embodiments of the present invention.

Referring to FIG. 4, hybridized aerogels manufactured according to embodiments of the present invention may be qualitatively analyzed by using FT-IR. It may be seen that SAT 10-5 and SAT 5-10 have generally similar graph shapes. Meanwhile, since SAT 15-0 does not contain titania (TiO₂) aerogel, it may have a somewhat different graph form from SAT 10-5 and SAT 5-10, which include titania (TiO₂) aerogel.

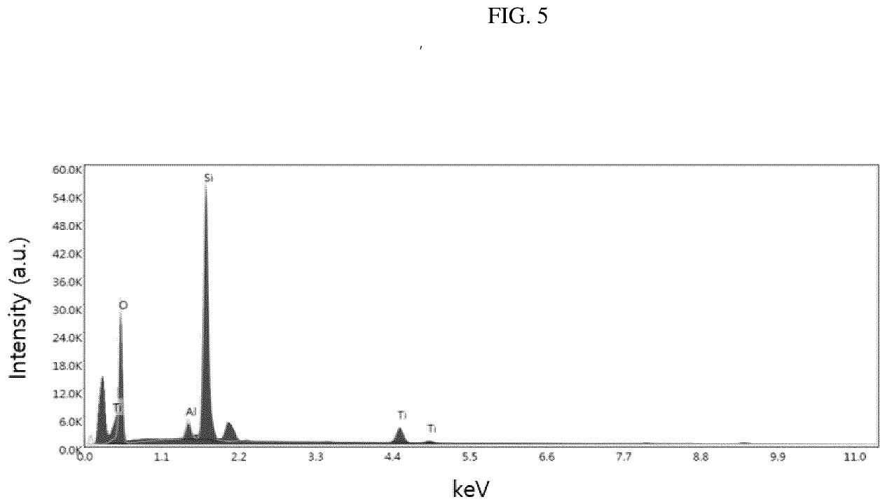

FIG. 5 is a graph showing the results of energy dispersive spectroscopy (EDS) analysis of the hybridized aerogel manufactured according to an embodiment of the present invention. The hybridized aerogel is a hybridized aerogel of silica-alumina-titania.

Referring to FIG. 5, it may be seen that the hybridized aerogel manufactured according to an embodiment of the present invention contains silicon Si, aluminum Al, titanium Ti, and oxygen O. The content of silicon Si may be higher than that of aluminum Al and titanium Ti.

Table 1 below summarizes the contents of the constituent elements (ingredients) of the hybridized aerogel obtained from the EDS analysis results of FIG. 5.

TABLE 1

| Element | Line Type | Wt % |
|---|---|---|
| O | K series | 53.9 |
| Al | K series | 2.83 |
| Si | K series | 36.56 |
| Ti | K series | 6.71 |

The results in FIG. 5 and Table 1 are merely exemplary, and the constituent elements and contents may vary depending on manufacturing conditions.

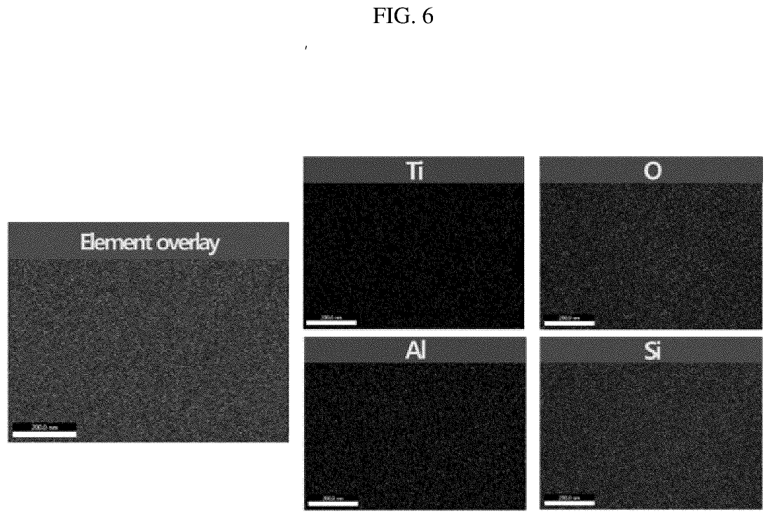

FIG. 6 is an EDS mapping analysis image for a hybridized aerogel manufactured according to an embodiment of the present invention. The hybridized aerogel is a hybridized aerogel of silica-alumina-titania.

Referring to FIG. 6, it is possible to confirm the mapping images for each of the silicon Si, aluminum Al, titanium Ti, and oxygen O elements included in the hybridized aerogel. FIG. 6 also includes an overlay image in which all elements are overlapped.

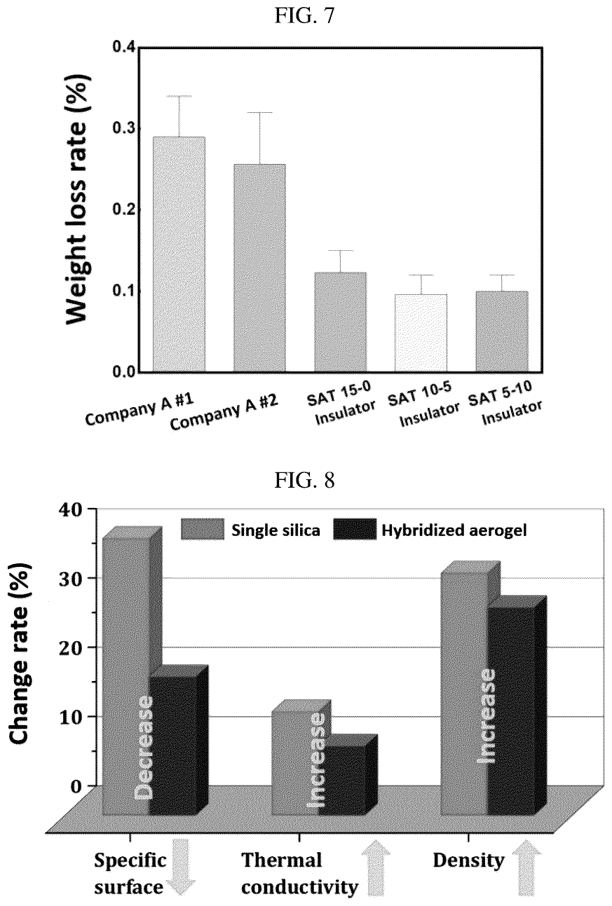

FIG. 7 is a graph showing the results obtained by a comparative evaluation of the weight reduction rate according to heat treatment of an aerogel-based insulator (aerogel blanket) to which a hybridized aerogel manufactured according to embodiments of the present invention is applied and an aerogel blanket commercialized in technologically advanced countries. In FIG. 7, Company A #1 and Company A #2 represent aerogel blankets commercialized in technologically advanced countries. SAT 15-0 insulator refers to an aerogel-based insulator (aerogel blanket) to which the previously described SAT 15-0 hybridized aerogel is applied, SAT 10-5 insulator refers to an aerogel-based insulator (aerogel blanket) to which the previously described SAT 10-5 hybridized aerogel is applied, and SAT 5-10 insulator refers to an aerogel-based insulator (aerogel blanket) to which the previously described SAT 5-10 hybridized aerogel is applied. The heat treatment was performed at 700° C. for 1 hour.

Referring to FIG. 7, it may be confirmed that a weight reduction rate due to heat treatment of the aerogel-based insulator (aerogel blanket) to which the hybridized aerogel according to an embodiment of the present invention is applied is tremendously lower as compared to that of the aerogel blankets (Company A #1, Company A #2) commercialized in technologically advanced countries. This means that the aerogel-based insulator to which the hybridized aerogel according to the embodiment of the present invention is applied has excellent high temperature stability. In addition, this means that the aerogel-based insulation material to which the hybrid aerogel according to the embodiment of the present invention is applied effectively suppresses scattering or loss of the opacifier even at high temperatures.

FIG. 8 is a graph showing the results obtained by comparative evaluation of the rate of change in specific surface area, thermal conductivity, and density according to heat treatment of a hybridized aerogel manufactured according to an embodiment of the present invention and a single silica aerogel. The heat treatment was performed at 700° C. for 1 hour.

Referring to FIG. 8, it may be confirmed that the change rates of the specific surface area, thermal conductivity, and density due to heat treatment of the hybridized aerogel according to an embodiment of the present invention are smaller than the respective change rates due to heat treatment of a single silica aerogel. Therefore, the hybridized aerogel according to an embodiment of the present invention may have excellent high temperature stability and maintain high insulation properties even at high temperatures.

Table 2 below summarizes the results of measuring the specific surface area, pore volume, pore size (average pore size), and thermal conductivity of the hybridized aerogels manufactured according to the embodiments of the present invention. Table 2 includes Brunauer-Emmett-Teller (BET) and Barrett-Joyner-Halenda (BJH) analysis results. Here, thermal conductivity is room temperature thermal conductivity.

TABLE 2

| | Specific | | | Thermal |
|---|---|---|---|---|
| | surface area | Pore volume | Pore size | conductivity |
| Sample | (m²/g) | (cm³/g) | (nm) | (mW/mK) |
| SAT 15-0 | 536.2 | 0.504 | 3.061 | 25 |
| SAT 10-5 | 507.2 | 0.564 | 4.046 | 24.2 |
| SAT 5-10 | 670.8 | 0.929 | 4.523 | 24 |

Referring to Table 2, it may be confirmed that SAT 15-0, SAT 10-5, and SAT 5-10 manufactured according to examples of the present invention have a high specific surface area and exhibit low thermal conductivity characteristics. In particular, SAT 5-10 had a specific surface area greater than 600 m2/g and exhibited thermal conductivity characteristics lower than 25 mW/mK.

According to the embodiments of the present invention described above, it is possible to implement an aerogel-based insulator which may prevent scattering problem by hybridizing the opacifier as a form of an aerogel, may also maintain high insulation properties by suppressing the deterioration of the pore structure and heat conduction in a high temperature environment, and may provide formability (moldability) and processability through hybridization (combination) with a matrix. In addition, according to an embodiment of the present invention, it is possible to implement an aerogel-based insulator which may secure high temperature stability and high insulation properties by preventing scattering of the opacifier and suppressing problems such as increased thermal conductivity, deterioration of pore characteristics, and deterioration of thermal insulation properties due to removal/reduction of the opacifier.

The aerogel-based insulator manufactured according to an embodiment of the present invention may have high insulation properties and, for example, may have a room temperature thermal conductivity of about 40 mW/mK or less. In addition, the aerogel-based insulator manufactured according to an embodiment of the present invention may have high insulation properties even at high temperatures due to the influence of the opacifier, and for example, has a thermal conductivity in the range of about 40 to 60 mW/mK in a high temperature environment.

In addition, since the aerogel-based insulator manufactured according to an embodiment of the present invention is a hybridization of the opacifier as a form of aerogel rather than powder, an effect may be obtained that scattering is greatly reduced or scattering is prevented may be obtained as compared to aerogel blankets commercialized in technologically advanced countries. In addition, because the aerogel-based insulator manufactured according to an embodiment of the present invention includes a hybridized aerogel, an effect may be obtained that the rate of change in thermal conductivity, density, and specific surface area due to high temperature heat treatment is reduced as compared to those of the commercialized aerogel blankets composed of a single phase in the technologically advanced countries.

In addition, since the aerogel-based insulator manufactured according to an embodiment of the present invention is an element in which the opacifier is uniformly hybridized as a form of aerogel rather than powder, it is possible to prevent/minimize removal of the opacifier, but also to improve structural stability, to simplify the manufacturing process and to improve the reproducibility of physical properties.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims. The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A hybridized aerogel comprising:
a silica aerogel; and
an opacifier aerogel mixed with the silica aerogel.

2. The hybridized aerogel of claim 1, wherein the opacifier aerogel includes at least one of alumina aerogel, titania aerogel, and zirconia aerogel.

3. The hybridized aerogel of claim 1, wherein a content of the opacifier aerogel in the hybridized aerogel is 35 wt % or less.

4. The hybridized aerogel of claim 1, wherein a room temperature thermal conductivity of the hybridized aerogel is 40 mW/mK or less, and a high-temperature thermal conductivity of the hybridized aerogel in a range of 300 to 1000° C. is in the range of 40 to 60 mW/mK.

5. A method of manufacturing a hybridized aerogel comprising:
preparing a silica sol including a silica precursor, a first organic solvent, and a first acidic catalyst;
preparing an opacifier sol including an opacifier precursor, a second organic solvent, a gelation inducing agent, and a second acidic catalyst;
forming a mixed sol by mixing the silica sol and the opacifier sol;
forming a hybridized gel in which a silica gel and an opacifier gel are mixed by adding a basic catalyst to the mixed sol and making the mixed sol to be gelled; and
acquiring a hybridized aerogel in which a silica aerogel and an opacifier aerogel are mixed by removing solvent from the hybridized gel.

6. The method of manufacturing a hybridized aerogel of claim 5,
wherein the preparing the opacifier sol includes at least one of preparing an alumina sol, preparing a titania sol, and preparing a zirconia sol,
wherein the opacifier aerogel includes at least one of alumina aerogel, titania aerogel, and zirconia aerogel.

7. The method of manufacturing a hybridized aerogel of claim 5,
wherein in the forming the mixed sol, the silica sol and the opacifier sol are mixed so that a molar ratio of the opacifier precursor to the silica precursor is 20% or less,
wherein the gelation inducing agent includes at least one of propylene oxide, cis-2,3-epoxybutane, 1,2-epoxybutane, glycidol, epibromohydrin, trimethylene oxide, and 3,3-dimethyloxetane.

8. An aerogel-based insulator comprising:
a matrix; and
a hybridized aerogel combined with the matrix, and including a silica aerogel and an opacifier aerogel mixed with the silica aerogel.

9. The aerogel-based insulator of claim 8,
wherein the matrix includes at least one of a blanket and a foam,
wherein the matrix includes at least one of mullite fiber, carbon fiber, glass wool, mineral wool, styrofoam, melamine foam, urethane foam, and phenolic foam.

10. The aerogel-based insulator of claim 8, wherein the matrix includes a fiber member having a diameter in a range of 1 to 10 μm, and a density in a range from 0.1 to 0.9 g/cm³.

11. The aerogel-based insulator of claim 8, wherein the opacifier aerogel includes at least one of alumina aerogel, titania aerogel, and zirconia aerogel.

12. The aerogel-based insulator of claim 8,
wherein a content of the opacifier aerogel in the hybridized aerogel is 35 wt % or less,
wherein a room temperature thermal conductivity of the hybridized aerogel is 40 mW/mK or less, and a high-temperature thermal conductivity of the hybridized aerogel in a range of 300 to 1000° C. is in a range of 40 to 60 mW/mK.

13. A method of manufacturing aerogel-based insulator comprising:
preparing a silica sol including a silica precursor, a first organic solvent, and a first acidic catalyst;
preparing an opacifier sol including an opacifier precursor, a second organic solvent, a gelation inducing agent, and a second acidic catalyst;
forming a mixed sol by mixing the silica sol and the opacifier sol;
forming a hybridized gel including a silica gel and an opacifier gel gelated from the mixed sol, and combined with a matrix by adding a basic catalyst to the mixed sol, and impregnating the matrix into the mixed sol to which the basic catalyst is added; and
acquiring an aerogel-based insulator including the matrix and a hybridized aerogel combined therewith by forming the hybridized aerogel in which a silica aerogel and an opacifier aerogel are mixed by removing solvent from the hybridized gel.

14. The method of manufacturing aerogel-based insulator of claim 13,
wherein the matrix includes at least one of a blanket and a foam,
wherein the matrix includes at least one of mullite fiber, carbon fiber, glass wool, mineral wool, styrofoam, melamine foam, urethane foam, and phenolic foam.

15. The method of manufacturing aerogel-based insulator of claim 13, wherein the matrix includes a fiber member having a diameter in a range of 1 to 10 μm, and a density in a range from 0.1 to 0.9 g/cm³.

16. The method of manufacturing aerogel-based insulator of claim 13,
wherein the preparing the opacifier sol includes at least one of preparing an alumina sol, preparing a titania sol, and preparing a zirconia sol,
wherein the opacifier aerogel includes at least one of alumina aerogel, titania aerogel, and zirconia aerogel.

17. The method of manufacturing aerogel-based insulator of claim 13,
wherein in the forming the mixed sol, the silica sol and the opacifier sol are mixed so that a molar ratio of the opacifier precursor to the silica precursor is 20% or less,
wherein the gelation inducing agent includes at least one of propylene oxide, cis-2,3-epoxybutane, 1,2-epoxybutane, glycidol, epibromohydrin, trimethylene oxide, and 3,3-dimethyloxetane.

18. The method of manufacturing aerogel-based insulator of claim 13, further comprising:
treating a surface of the matrix with acid before impregnating the matrix into the mixed sol, and
heat treating the matrix at a temperature of 300 to 900° C. before impregnating the matrix into the mixed sol.

19. The method of manufacturing aerogel-based insulator of claim 13,
wherein the forming the hybridized gel involves a process of immersing the matrix in the mixed sol, impregnating the matrix under a vacuum condition in a range of 0.1 to −0.1 MPa, and then gelling the mixed sol at a temperature of 40 to 60° C.,
wherein the method of manufacturing aerogel-based insulator further includes performing aging and solvent exchange for the hybridized gel between the forming the hybridized gel and the acquiring the aerogel-based insulator.

20. The method of manufacturing aerogel-based insulator of claim 13, further comprising post-heat treating the aerogel-based insulator, wherein the post-heat treating for the aerogel-based insulator is performed at a temperature of 300 to 900° C. in air, oxygen, or inert gas atmosphere.
